(19) United States
(12) Patent Application Publication
(10) Pub. No.: US 2024/0112476 A1
(43) Pub. Date: Apr. 4, 2024

(54) DRUG IDENTIFICATION APPARATUS, DRUG IDENTIFICATION METHOD AND PROGRAM

(71) Applicant: FUJIFILM Toyama Chemical Co., Ltd., Tokyo (JP)

(72) Inventor: Shinji HANEDA, Tokyo (JP)

(73) Assignee: FUJIFILM Toyama Chemical Co., Ltd., Tokyo (JP)

(21) Appl. No.: 18/473,551

(22) Filed: Sep. 25, 2023

(30) Foreign Application Priority Data
Sep. 26, 2022 (JP) 2022-152972

(51) Int. Cl. G06V 20/60; G06F 16/14; G06V 10/56; G06V 10/75; G06V 10/764; G06V 10/77; G06V 10/94

(52) U.S. Cl. CPC G06V 20/60; G06F 16/156; G06V 10/56; G06V 10/75; G06V 10/764; G06V 10/77; G06V 10/945

(57) ABSTRACT

One or more processors calculate a first score value indicating likelihood of being a type of the identification target drug with respect to each of a plurality of types of drugs from the image by using a first trained model trained to identify a type of an identification target drug from an image obtained by capturing the identification target drug, identify one or more appearance attributes of the identification target drug from the image, acquire information on drug types matching the attributes of the identification target drug from the drug master file including information on one or more appearance attributes regarding each of a plurality of types of drugs identifiable by the first trained model, calculate a second score value by using the first score value and a value being set for the attribute; and present a candidate for the type of the identification target drug based on second score value.

### CROSS-REFERENCE TO RELATED APPLICATION

The present application claims priority under 35 U.S.C. § 119(a) to Japanese Patent Application No. 2022-152972 filed on Sep. 26, 2022, which is hereby expressly incorporated by reference, in its entirety, into the present application.

### BACKGROUND OF THE INVENTION

### 1. Field of the Invention

The present disclosure relates to a drug identification apparatus, a drug identification method and a program. Particularly, the present disclosure relates to an image recognition technique and a machine learning technology that identify a type of a drug from an image obtained by capturing the drug.

### 2. Description of the Related Art

As one of techniques for efficiently performing tasks such as drug dispensing audit or identification of a drug brought by a patient, there has been developed artificial intelligence (AI) that identifies a type of a drug from an image obtained by capturing the drug. Japanese Patent No. 6742859 discloses a tablet detection method, involving a case where one or more tablets to be taken as one dosage are packaged in one packaging bag and the tablets include a split tablet. The method includes: a capturing step of capturing a reflected light image and a transmitted light image of the packaging bag; an extracting step of extracting tablet regions based on the reflected light image and the transmitted light image, the tablet regions being regions corresponding to the tablets in the reflected light image; a first identification step of outputting an identification value for uniquely identifying each of the tablets by comparing a dimension (size) and a color of the respective tablet regions extracted in the extracting step with a model information on a shape and a color of the tablet; and a second identification step of, if there are a plurality of reference data pieces that have feature values substantially matching that of the extracted tablet region or if the identification value that is improperly detected is output even though the feature value does not match any of the reference data pieces in the first identification step, outputting the identification value for the tablet that is improperly detected in the first identification step by using a learning model generated by machine learning based on training data including images of a plurality of similar tablets, which are a plurality of tablets having feature values similar to each other.

International Publication No. WO 2022/092130 discloses a type identification device including: an image generation unit configured to generate an extracted-mark image acquired by extracting a mark shown in a captured image obtained by capturing (imaging) a target drug whose type is unknown, based on an output value acquired by inputting the captured image to a trained model constructed to extract a mark formed on the drug; and an identification unit configured to identify a type of the target drug based on a result of a comparison between the extracted-mark image generated by the image generation unit and a registered-mark image that is pre-registered for each type of drug.

### CITATION LIST

Patent Literature 1: Japanese Patent No. 6742859

Patent Literature 2: International Publication No. WO 2022/092130

### SUMMARY OF THE INVENTION

In generation of a drug identification model, which is a machine learning model (AI model) that identifies a type of a drug based on an input image obtained by capturing the drug, machine learning such as deep learning is applied by using training data including pairs of data each of which has an image of a drug and a ground truth of a type of the drug. Such a drug identification model automatically learns feature values from training data and can identify a type of a drug with high precision from an image input thereto.

For example, a drug identification model, which is trained to identify N types of drug types, receives as input, an image obtained by capturing an identification target drug and calculates a score value indicating likelihood (certainty factor) of being the type of the identification target drug, for each of all of the N types of drug types learned. Then, in order of magnitude of the score value for each of the drug types output from the drug identification model, that is, in decreasing order of likelihood, higher drug types are presented as candidates for the type of the identification target drug. Based on a score value for each drug type output from the drug identification model, a plurality of higher-ranking candidates are presented as an estimation result for one identification target drug, and a user finally determines a correct type of the drug to confirm the type of the identification target drug.

However, generally, a feature value learned by a drug identification model may not match human sense. As such, higher-ranking candidates presented based on a score value output from the drug identification model do not necessarily match human sense of similarity. For example, a plurality of candidates with higher score values presented as an identification result by the drug identification model may sometimes include drug candidates having dissimilar appearance characteristics (having totally different appearance attribute) that can be determined by human sense, as being clearly different from the identification target drug. Therefore, a user may have strange feeling in the candidates for the drug type presented from the drug identification apparatus, and doubt reliability of identification performance of the drug identification apparatus.

The present disclosure has been made in such a circumstance, and aims to provide a drug identification apparatus, a drug identification method, and a program (and a recording medium which records the program thereon) that can present reasonable candidates for the drug type even in view of human sense, while using a trained machine learning model that identifies the drug type from an image obtained by capturing the drug.

A drug identification apparatus according to a first aspect of the present disclosure includes one or more processors and one or more storages, wherein the one or more storages are configured to store: a first trained model trained to identify a type of an identification target drug from an image obtained by capturing the identification target drug; and a drug master file including information on one or more appearance attributes for each of a plurality of types of drugs, and the one or more processors are configured to: calculate a first score value indicating likelihood of being a type of the identification target drug, for each of a plurality of types of drugs identifiable from the image by the first trained model; identify one or more appearance attributes of the identification target drug from the image; acquire from the drug master file, information on types of drugs matching the one or more appearance attributes of the identification target drug, and calculate a second score value by using the first score value and values set for the one or more appearance attributes; and present candidates for the type of the identification target drug based on the second score value.

With the drug identification apparatus according to the first aspect, from the first score value for each of the types of drugs calculated by the first trained model, the second score value is calculated in consideration of one or more appearance attributes of the identification target drug. Then, candidates for the type of the identification target drug are presented based on the second score value. The appearance attributes of a drug is an attribute that can be visually recognized by human sense. From visual recognition, a human has an impression regarding whether drugs are similar or not. The first score value calculated by the first trained model does not necessarily match human sense of similarity, but the second score value can be close to human sense of similarity since it is calculated in consideration of the appearance attributes of the identification target drug.

According to the first aspect, while allowing accurate identification of the identification target drug by using the first trained model, it is possible to present candidates for a drug type of the identification target drug, so as to be reasonable for human. The term “identify” embraces concepts such as discriminate, determine, estimate, infer, and predict.

The processing of identifying appearance attributes of the identification target drug from the image obtained by capturing the identification target drug may be executed by using a trained model generated by machine learning or may be executed by applying an image processing technology based on a method including pattern matching and so on, other than machine learning.

According to a second aspect, in the drug identification apparatus according to the first aspect, the one or more storages may be configured to store a second trained model trained to identify one or more appearance attributes of the identification target drug from the image, and the one or more processors may be configured to identify whether or not the identification target drug belongs to a category corresponding to the one or more appearance attributes by using the second trained model.

According to a third aspect, in the drug identification apparatus according to the first or second aspect, the values set for the appearance attributes may be values depending on significances of the one or more appearance attributes. For example, as the significance increases, the values are set to be increased.

According to a fourth aspect, in the drug identification apparatus according to the third aspect, the one or more processors may be configured to receive an instruction to change settings for the significances, and set values depending on the significances of the appearance attributes based on the received instruction.

According to a fifth aspect, in the drug identification apparatus according to the fourth aspect, the values depending on the significances may be settable for each user.

According to a sixth aspect, in the drug identification apparatus according to the fourth or fifth aspect, the values depending on the significances may be settable at a time desired by a user.

According to a seventh aspect, in the drug identification apparatus according to any one of the third to sixth aspects, an input device may be provided, and the one or more processors may be configured to receive an instruction regarding the settings for the significances from the input device.

According to an eighth aspect, in the drug identification apparatus according to any one of the third to seventh aspects, the drug master file may include information on a plurality of appearance attributes including an attribute relating to a shape of a drug and an attribute relating to a color thereof, and the one or more processors may be configured to receive an instruction to specify whether the second score value is calculated with importance placed on the attribute relating to a shape or the attribute relating to a color, and change significance of at least one of the attribute relating to a shape and the attribute relating to a color, based on the received instruction.

According to a ninth aspect, in the drug identification apparatus according to any one of the third to eighth aspects, the one or more processors may be configured calculate the second score value by adding a value depending on the significance of each appearance attribute, to the first score value for each of the types of drugs matching the one or more appearance attributes of the identification target drug.

According to a tenth aspect, in the drug identification apparatus according to any one of the first to ninth aspects, the one or more processors may be configured to calculate the second score value by modifying the first score value for each of the types of drugs matching the one or more appearance attributes of the identification target drug, with a value set for each appearance attribute.

According to an eleventh aspect, in the drug identification apparatus according to any one of the first to tenth aspects, the drug master file may include information on a plurality of appearance attributes including an attribute relating to at least one of a shape and a color of a drug, and the one or more processors may be configured to identify whether the identification target drug matches the plurality of appearance attributes or not.

According to a twelfth aspect, in the drug identification apparatus according to any one of the first to eleventh aspects, the one or more processors may be configured to present a drug candidate list in which the candidates are arranged in order of magnitude of the second score value.

According to a thirteenth aspect, the drug identification apparatus according to any one of the first to twelfth aspects, may be provided with a display configured to display the candidates for the type of the identification target drug.

According to a fourteenth aspect, the drug identification apparatus according to any one of the first to thirteenth aspects, may be provided with a camera configured to capture an image of the identification target drug.

According to a fifteenth aspect of the present disclosure, a drug identification method to be executed by one or more processors, includes: with a first trained model trained to identify a type of an identification target drug from an image obtained by capturing the identification target drug, calculating from the image, a first score value indicating likelihood of being a type of the identification target drug, for each of a plurality of types of drugs; identifying from the image, one or more appearance attributes of the identification target drug; acquiring information on types of drugs matching the one or more appearance attribute of the identification target drug, from drug master file including information on one or more appearance attributes, for each of a plurality of types of drugs identifiable by the first trained model; calculating a second score value by using the first score value and values set for the one or more appearance attributes, based on information on types of drugs matching the one or more appearance attributes of the identification target drug; and presenting candidates for the type of the identification target drug based on the second score value.

The drug identification method according to the fifteenth aspect may be configured to include the same specific aspects as those of the drug identification apparatus according to any one of the second to fourteenth aspects.

According to sixteenth aspect of the present disclosure, a program causes a computer to implement the functions including: a function of, with a first trained model trained to identify a type of an identification target drug from an image obtained by capturing the identification target drug, calculating from the image, a first score value indicating likelihood of being a type of the identification target drug, for each of a plurality of types of drugs; a function of identifying from the image, one or more appearance attributes of the identification target drug; a function of acquiring information on types of drugs matching the one or more appearance attributes of the identification target drug, from drug master file including information on the one or more appearance attributes, for each of a plurality of types of drugs identifiable by the first trained model; a function of calculating a second score value by using the first score value and values set for the one or more appearance attributes, based on information on types of drugs matching the one or more appearance attributes of the identification target drug; and a function of presenting candidates for the type of the identification target drug based on the second score value.

The program according to the sixteenth aspect may be configured to embrace the same specific aspects as those of the drug identification apparatus according to any one of the second to fourteenth aspects.

According to the present disclosure, a drug type can be identified highly precisely using a first trained model that is trained to identify a type of a drug from an image obtained by capturing the drug, and present reasonable candidates even in view of human visual sense.

### BRIEF DESCRIPTION OF THE DRAWINGS

FIG. 1 is a front perspective view of a smartphone;

FIG. 2 is a back perspective view of the smartphone;

FIG. 3 is a block diagram showing an electrical configuration of the smartphone;

FIG. 4 is a block diagram showing a functional configuration of a drug identification apparatus according to an embodiment;

FIG. 5 is a table showing setting examples of information included in a drug master file and their significances;

FIG. 6 is an explanatory diagram showing an example of processing to be executed by a drug identification apparatus according to the embodiment; and

FIG. 7 is a flowchart showing an example of a drug identification method to be executed by a drug identification apparatus according to the embodiment.

### DESCRIPTION OF THE PREFERRED EMBODIMENTS

Preferred embodiments of the invention are described below with reference to attached drawings.

### Outline of Drug Identification Apparatus According to Embodiment

A drug identification apparatus according to an embodiment of the present disclosure uses: a drug identification model that is a trained machine learning model having learned (trained) to identify a type of a drug from an image obtained by capturing the drug; an attribute classification model that is a trained machine learning model having learned to identify appearance attributes for the drug that a human can recognize from the image obtained by capturing the drug; and a drug master file that records information on the appearance attributes for each of types of drugs to modify score values. When images of an identification target drug are input to the drug identification model, score values for respective types of drugs (drug types) are output from the drug identification model. The score values for respective drug types are modified in consideration of an appearance attribute of the identification target drug with reference to the drug master file by using an output from the attribute classification model. Based on the modified score values, it is possible to present candidates close to the human sense of similarity. Note that each of the drug identification model and the attribute classification model is substantively a program.

The drug identification apparatus is, for an example, may be installed on a mobile terminal apparatus. The mobile terminal apparatus includes at least one of a smartphone, a mobile phone, a personal handy-phone system (PHS), a personal digital assistant (PDA), a tablet type computer terminal, a notebook type personal computer terminal, a wearable terminal, and a portable game player. Hereinafter, a drug identification apparatus implemented by hardware and software of a smartphone is exemplarily described in detail with reference to drawings.

### Appearance of Smartphone

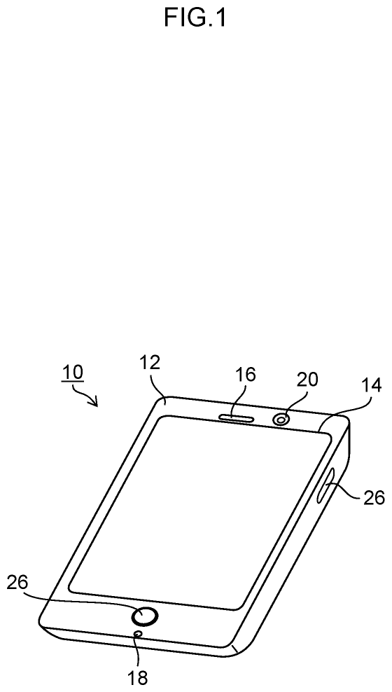

FIG. 1 is a front perspective view of a smartphone 10 functioning as the drug identification apparatus according to the embodiment. As shown in FIG. 1, the smartphone 10 has a planer housing 12. The smartphone 10 includes a touch panel display 14, a speaker 16, a microphone 18, and an in-camera 20 on a front side of the housing 12.

The touch panel display 14 includes a display unit configured to display an image and the like and a touch panel unit arranged on a front surface of the display unit and configured to receive a touch input. The display unit is, for example, a color liquid crystal display (LCD) panel or a color organic electro-luminescence (EL) panel.

The touch panel unit is, for example, a capacitive touch panel that is planarly provided on a light-transmissive substrate body. The capacitive touch panel has includes: position detection electrodes having light-transmittance; and an insulating layer that is provided on the position detection electrodes. The touch panel unit is configured to generate and output two-dimensional positional coordinates information corresponding to a user's touch operation. Examples of the touch operation include a tap operation, a double-tap operation, a flick operation, a swipe operation, a drag operation, a pinch-in operation, and a pinch-out operation.

The speaker 16 is a sound output unit configured to output sound while talking and playing a moving image. The microphone 18 is a sound input unit configured to receive input of sound while talking and capturing (taking) a moving image. The in-camera 20 is an imaging device configured to capture a moving image and a still image.

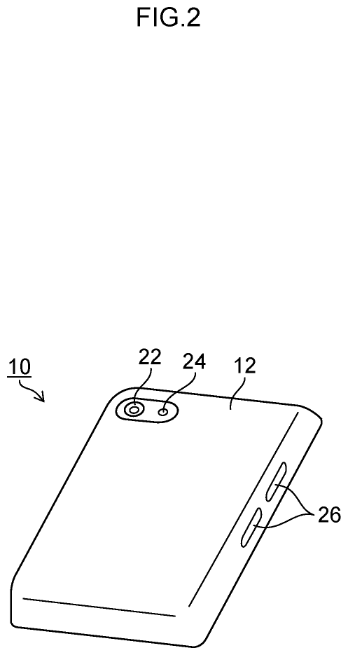

FIG. 2 is a back perspective view of the smartphone 10. As shown in FIG. 2, the smartphone 10 includes an out-camera 22 and a light 24 on a back surface of the housing 12. The out-camera 22 is an imaging device configured to capture a moving image and a still image. The light 24 is a light source configured to radiate illuminating light for capturing with the out-camera 22 and is composed of, for example, a light emitting diode (LED).

Further, as shown in FIGS. 1 and 2, the smartphone 10 includes switches 26 on front and side surfaces of the housing 12. The switch 26 is an input member configured to receive an instruction from a user. The switch 26 is a push-button type switch configured to be turned on when pressed with a finger or the like and be turned off when the finger is moved off the switch because of the resilience of a spring or the like therein.

Note that the configuration of the housing 12 is not limited thereto but may adopt a configuration having a collapsible structure or a slide mechanism.

### Electrical Configuration of Smartphone

The smartphone 10 includes, as its main function, wireless communication functionality that performs mobile wireless communication via a base station device and over a mobile communication network.

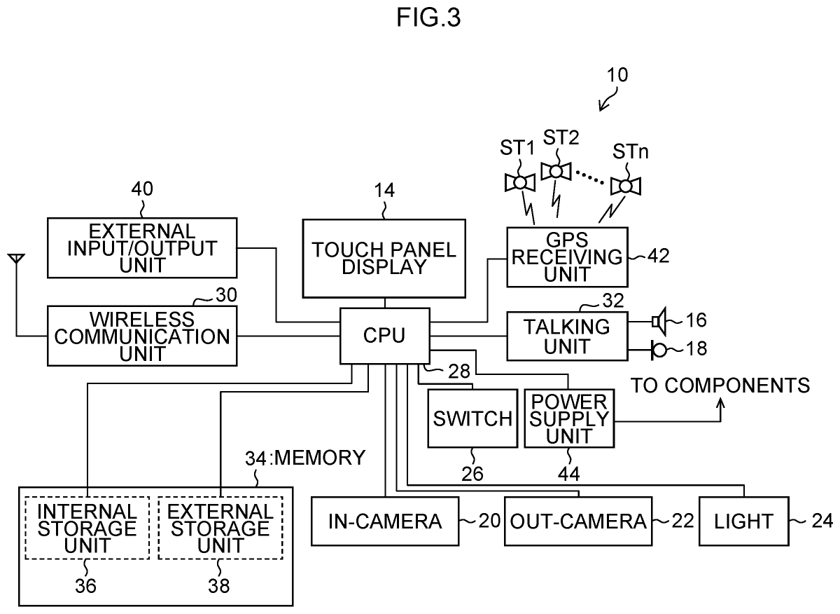

FIG. 3 is a block diagram showing an electrical configuration of the smartphone 10. As shown in FIG. 3, the smartphone 10 includes a central processing unit (CPU) 28, a wireless communication unit 30, a talking unit 32, a memory 34, an external input/output unit 40, a GPS receiving unit 42, and power supply unit 44, in addition to the touch panel display 14, speaker 16, the microphone 18, in-camera 20, out-camera 22, light 24, and switch 26 described above.

The CPU 28 is an example of a processor configured to execute an instruction stored in the memory 34. The CPU 28 is configured to operate in accordance with a control program and control data stored in the memory 34 and to integrally control components of the smartphone 10. The CPU 28 has a mobile communication control function for controlling communication-related components and an application processing function, in order to perform sound communication and data communication through the wireless communication unit 30.

The CPU 28 further includes an image processing function for displaying a moving image, a still image, text and the like on the touch panel display 14. With the image processing function, information on a still image, a moving image, text and so on is visually conveyed to a user. The CPU 28 is further configured to acquire two-dimensional positional coordinates information corresponding to a user's touch operation through the touch panel unit of the touch panel display 14. The CPU 28 is further configured to acquire an input signal from the switch 26.

Each of the in-camera 20 and the out-camera 22 includes an imaging lens, a diaphragm, an imaging device, an analog front end (AFE), an analog to digital (A/D) converter, a lens driving unit, and the like, not shown. The in-camera 20 and out-camera 22 are configured to capture a moving image and a still image in accordance with an instruction from the CPU 28.

The CPU 28 may convert a moving image and a still image captured by the in-camera 20 and the out-camera 22 to compressed image data such as Moving Picture Experts Group (MPEG) data and Joint Photographic Experts Group (JPEG) data.

The CPU 28 stores a moving image and a still image captured by the in-camera 20 and out-camera 22 in the memory 34. The CPU 28 further outputs a moving image and a still image captured by the in-camera 20 and out-camera 22, externally to the smartphone 10 through the wireless communication unit 30 or the external input/output unit 40.

The CPU 28 further displays a moving image and a still image captured by the in-camera 20 and out-camera 22 on the touch panel display 14. The CPU 28 may utilize a moving image and a still image captured by the in-camera 20 and out-camera 22 within application software.

Note that the CPU 28 may further turns on the light 24 to illuminate a subject with fill-in light (auxiliary light) when capturing an image by the out-camera 22. Turning on and off of the light 24 may be controlled in response to a touch operation on the touch panel display 14 or an operation on the switch 26 by a user.

The wireless communication unit 30 is configured to perform wireless communication between a base station device corresponding to a mobile communication network compatible with 4th generation (4G) or 5th generation (5G) standard or the like in accordance with an instruction from the CPU 28. The smartphone 10 is configured to use the wireless communication to transmit and receive various file data such as sound data and image data, e-mail data, and the like, and receive World Wide Web (web for short) data, streaming data, and the like.

The speaker 16 and the microphone 18 are connected to the talking unit 32. The talking unit 32 is configured to decode sound data received through the wireless communication unit 30 and to output the decoded data through the speaker 16. The talking unit 32 is configured to convert user's voice input through the microphone 18 to sound data processable by the CPU 28, and output the converted data to the CPU 28.

The memory 34 is configured to store instructions for causing the CPU 28 to execute the instructions. The memory 34 includes an internal storage unit 36 internally provided in the smartphone 10 and an external storage unit 38 removably provided in the smartphone 10. The internal storage unit 36 and the external storage unit 38 are implemented by using publicly known storage media.

The memory 34 is configured to store a control program for the CPU 28, control data, application software, address data in which a name, a telephone number and so on of the other communication party are associated with each other, data of transmitted and received e-mails, Web data downloaded through Web browsing, downloaded contents data and the like. The memory 34 may further be configured to temporarily store streaming data and the like.

The external input/output unit 40 serves as an interface to an external apparatus coupled to the smartphone 10. The smartphone 10 is connected to another external apparatus directly or indirectly through communication and the like via the external input/output unit 40. The external input/output unit 40 is configured to convey data received from an external apparatus to a component within the smartphone 10 and to transmit internal data in the smartphone 10 to an external apparatus.

Examples of means for communication and the like include universal serial bus (USB), Institute of Electrical and Electronics Engineers (IEEE) 1394, the Internet, wireless local area network (LAN), Bluetooth (registered trademark), radio frequency identification (RFID), and infrared-ray communication. Also, examples of the external apparatus include a headset, an external charger, a data port, an audio equipment, a video equipment, a smartphone, a PDA, a personal computer, and an earphone.

The GPS receiving unit 42 is configured to detect a location of the smartphone 10 based on positioning information from GPS satellites ST1, ST2, . . . , STn.

The power supply unit 44 is a power supply source configured to supply power to components of the smartphone 10 through a power supply circuit, not shown. The power supply unit 44 includes a lithium-ion secondary battery, for example. The power supply unit 44 may include an AC/DC converting unit configured to generate DC voltage from an external AC power supply.

The smartphone 10 configured as described above is set to a capturing mode in response to an instruction input from a user through the touch panel display 14 or the like so that a moving image and a still image can be captured by the in-camera 20 and the out-camera 22.

In a case where the smartphone 10 is set to the image-capturing mode, the smartphone 10 transits into a capturing standby state. A moving image is captured by the in-camera 20 or the out-camera 22, and the captured moving image is displayed as a live-view image, on the touch panel display 14. That is, images captured by the cameras 22 are continuously displayed on the touch panel display 14.

A user visually checks the live-view image displayed on the touch panel display 14 so that the user can determine image composition, check a subject to be captured, and set a capturing condition.

In the capturing standby state, when the smartphone 10 receives instruction to capture an image from a user via the touch panel display 14 or the like, the smartphone 10 performs autofocus (AF) and auto-exposure (AE) controls, and captures and stores a moving image and a still image.

The memory 34 is an example of the “storage device” in the present disclosure. The touch panel display 14 is an example of the “input device” and “display” in the present disclosure. Each of the in-camera 20 and the out-camera 22 is an example of the “camera” in the present disclosure.

### Functional Configuration of Drug Identification Apparatus

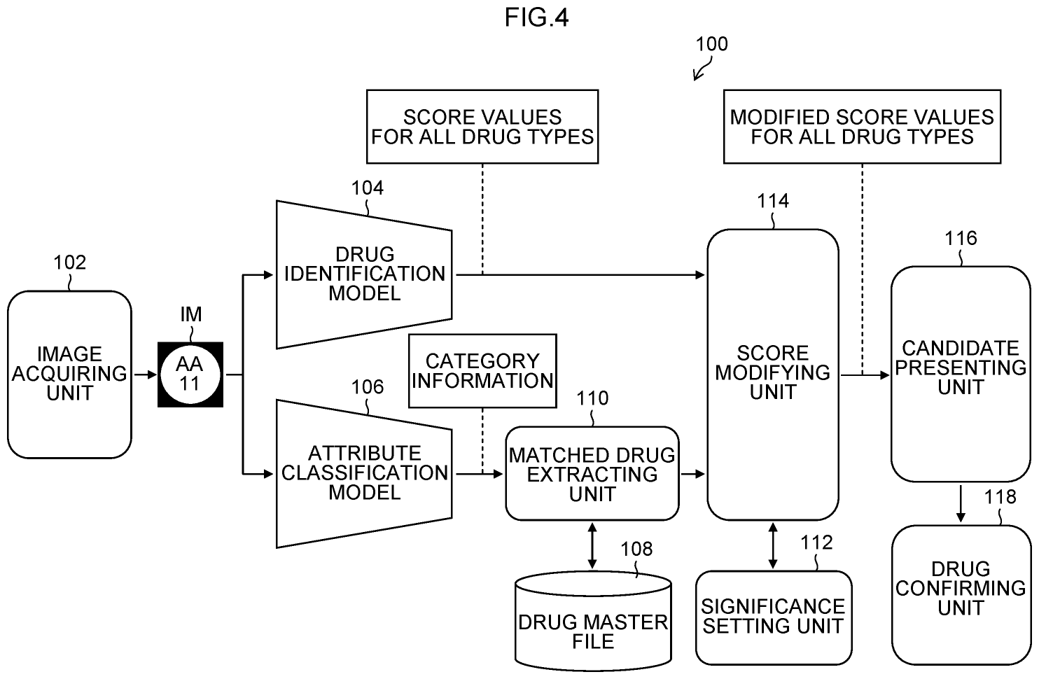

FIG. 4 is a block diagram showing a functional configuration of the drug identification apparatus 100 implemented by the smartphone 10. Each function of the drug identification apparatus 100 is embodied when the CPU 28 executes a program stored in the memory 34. As shown in FIG. 4, the drug identification apparatus 100 includes an image acquiring unit 102, a drug identification model 104, an attribute classification model 106, a drug master file 108, a matched drug extracting unit 110, a significance setting unit 112, a score modifying unit 114, a candidate presenting unit 116, and a drug confirming unit 118.

The image acquiring unit 102 acquires a captured image that is a still image obtained by capturing an identification target drug. The captured image may be an image captured by, for example, the in-camera 20 or the out-camera 22. The captured image may be an image acquired from another apparatus via the wireless communication unit 30, the external storage unit 38, or the external input/output unit 40. The captured image may show a plurality of identification target drugs. The plurality of identification target drugs shown in the captured image are not limited to drugs of the same drug type, and may be drugs of different drug types. The captured image may be an image obtained by capturing an identification target drug in a state where the identification target drug is accommodated in a packaging bag. The packaging bag is required to be entirely or partially transparent or translucent.

According to this embodiment, an aspect in which an image IM showing only one drug to be identified is to be processed, is described as an example. In a case where an image obtained by collectively capturing mixture of drugs of different types is processed, each of drug regions may be detected from the captured image where the drugs are shown, and an image (extracted image for each drug) extracted from each drug region may be processed for each of the drugs.

The captured image may be an image obtained by capturing an identification target drug and a marker. In this case, the marker functions as a reference for standardizing a photographing distance and a photographing viewpoint when capturing a image. The marker may be: a form in which markers having an identical shape are provided and representative points of respective markers are used as a reference point for the standardization; or a form in which a single marker is provided and feature points included in the marker are used as reference points for the standardization. In a case of the form in which markers having an identical shape are provided, each of the markers may be, for example, an ArUco marker, a circle marker, a square marker, or the like. The markers are arranged at, for example, four corners of a rectangular region where the drug is placed. The captured image may be an image obtained by capturing an identification target drug and gray color serving as a reference. On the other hand, in a case of the form in which a single marker is provided, the marker may have a square shape or a backwards C shape (a shape in which one side of a rectangle is missing or so-called U-shape). The single marker is arranged so as to surround a rectangular region where the drug is placed. In this case, each of the points at four corners of the square shape or a backwards C shape serves as a reference point for the standardization.

The captured image may be an image obtained with a standard photographing distance and photographing viewpoint when image-capturing. The photographing distance can be represented by a distance between the identification target drug and an imaging lens and a focal length of the imaging lens. Also, the photographing viewpoint can be represented by an angle formed by a surface on which the marker is printed and an optical axis of the imaging lens.

The image acquiring unit 102 includes an image correcting unit, not shown. When the marker is shown in the captured image, the image correcting unit performs standardization of the photographing distance and photographing viewpoint of the captured image based on the marker to obtain a standardized image. The standardized image may be an image obtained by performing standardization processing on the captured image and then extracting an inner region of a rectangle which has, as its vertices, markers at four corners thereof. For example, the image correcting unit designates destination coordinates to which the four vertices of the square having coordinates specified by the markers move after the standardization of a photographing distance and a photographing viewpoint. The image correcting unit determines a perspective transform matrix so that the positions of the four vertices are transformed to respective positions of the designated coordinates. Such a perspective transform matrix can be uniquely defined as long as there are four points. For example, with getPerspectiveTransform function of open source computer vision library (OpenCV), a transform matrix can be obtained as long as there is a correspondence relationship between the four points.

The image correcting unit uses the perspective transform matrix to perform perspective transform on the entire original captured image, and acquires an image after the transformation. Such a perspective transform can be executed by using the warpPerspective function of OpenCV. The image after the transformation may be a standardized image in which the photographing distance and photographing viewpoint are standardized.

Further, in a case where a region having a gray color as a reference is included in the captured image, the image correcting unit may perform tone correction on the captured image based on the reference gray color.

The drug identification model 104 is a trained AI model which is trained by machine learning so as to identify a type of a drug from an input image IM, that is, to perform a task of so-called object recognition. The type of drug to be identified by the drug identification model 104 is a drug type that can be specified based on identification information, for example, YJ code (individual drug code), a drug name, or the like. The drug identification according to the embodiment can be defied as an action of determining a drug in YJ code corresponding to the identification target drug. This is just an example of the definition of the drug identification. For example, an identification code may be defined by using a code type other than YJ code.

The drug identification model 104 functions as a multiclass classifier configured to: receive input of an image IM obtained by capturing an identification target drug; identify a type of the identification target drug within the image IM; and classify the identified drug type into at least one of learned N types of drug types (classes). That is, when the drug identification model 104 receives input of an image IM, the drug identification model 104 calculates score values indicating accuracies (certainty factors) that the identification target drug is a drug i, for respective drugs i of all learned N types. The letter “i” in the notation “drugs i” refers to an index for distinguishing a drug type in the learned N types of drugs. For each drug i, the drug identification model 104 calculates a score value serving as an indicator for determining whether the identification target drug is a drug i.

The drug identification model 104 is formed by using, for example, a neural network. As a machine learning model preferable for image recognition, convolution neural network (CNN) may be used, for example. The image IM to be input to the drug identification model 104 may be a region image of the identification target drug extracted from a captured image. Note that, in addition to the image IM, engraved-mark information and the like extracted from the image IM may be input to the drug identification model 104.

The drug identification model 104 may be a model which has been trained to be capable of: receiving input of a one-side image obtained by capturing the identification target drug from its one surface side (from one direction); and identifying a type of the identification target drug and which side of the identification target drug is captured in the one-side image (whether the captured side is a front side or a back side). The drug identification model 104 is an example of the “first trained model” in the present disclosure.

The attribute classification model 106 is a trained AI model which has been trained by machine learning to be capable of: receiving input of an image IM; identifying an appearance attribute of the identification target drug within the image IM, and determining whether the attribute belongs to a category j corresponding to each of the attributes that are recognizable from its appearance by a human visual sense. The letter “j” in the notation “category j” is an index for distinguishing among categories respectively corresponding to attributes recognizable from appearance by a human visual sense. The attribute classification model 106 is an example of the “second trained model” in the present disclosure.

Examples of the categories to be learned by the attribute classification model 106 may include a circle, a triangle, a square, a pentagon, an opaque capsule, a transparent capsule, a two-color capsule, a one-color capsule, red, blue, yellow, white and the like.

The attribute classification model 106 is configured to, from an image input IM input thereto, output category information indicating the appearance attribute of the identification target drug within the image IM. The attribute classification model 106 may output a score value which definitely determines whether the appearance attribute belongs to each of the categories j or not, or may be a score value which indicate likelihood (certainty factor) that the appearance attribute belongs to each of the categories j. That is, the score values output by the attribute classification model 106 may be discrete values of “0” or “1” , or may be continuous values. Further, the continuous score values may be binarized with reference to a threshold value set therefor so that the resulting binary score values may be used as the definitely determined score values.

Note that while the attribute classification model 106 functions as a multiclass classifier configured to classify identification target drugs into categories (classes), the fineness (granularity) of the classification of the attribute classification model 106 is different from that of the drug identification model 104. The number of drug types to be identified by the drug identification model 104 is, for example, the order of several thousands to several tens of thousands while the number of categories to be identified by the attribute classification model 106 is, for example, the order of several tens, leading to a great difference in granularity of the classification. One drug may belong to a plurality of categories.

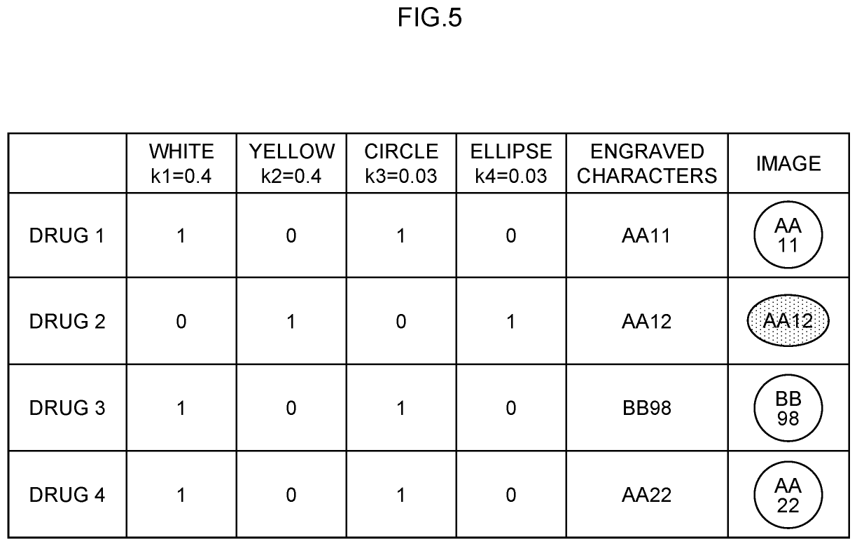

The drug master file 108 is a database for master data including information on whether each of N types of drugs i belongs to a category j or not (see FIG. 5). The drug master file 108 includes information indicating appearance attributes of all of N types of drugs i identifiable by the drug identification model 104. Note that, the drug master file 108 is not necessarily stored in the memory 34 in the smartphone 10. The drug master file 108 may be stored in an external device on a network communicably connected to the smartphone 10, such as a cloud server, not shown.

The matched drug extracting unit 110 refers to the drug master file 108 based on the category information output from the attribute classification model 106, and acquires, from the drug master file 108, information on a drug type belonging to the same category as that of the identification target drug.

The significance setting unit 112 sets a significance to each category j. The value depending on the significance may be a predetermined fixed value. However, it is preferable that the significance setting unit 112 is configured so that the setting of a significance can be customized for each user or at a timing desired by a user. For example, in a case where the significance setting unit 112 receives an instruction to change the significance setting from a user via a user interface, the user is prompted to select one of options such as “color-oriented” and “shape-oriented” through a graphical user interface (GUI) button or a setting screen of the corresponding application software so that the significance setting may be changed for each user or for each timing when the user determines whether to confirm a drug type. If “color-oriented” is selected, a value that relatively increases the significance of a category relating to “color” is set while, if “shape-oriented” is selected, a value that relatively increases the significance of a category relating to “shape” is set.

In addition, the CPU 28 may store setting information relating to the significance in the memory 34 in association with user information, and read out the stored setting information for each user based on user information so that it is possible to reproduce the settings for each user. Regardless of time, such as before or after the image IM is acquired or while candidates presented by the candidate presenting unit 116 is being displayed, the CPU 28 preferably provides a GUI for receiving the instruction to change a setting relating to the significance, and changes the setting as needed at a timing when instructed by a user.

For the score value sᵢ of each drug i output from the drug identification model 104, the score modifying unit 114 modifies the score value of each of the drug types having the same appearance attributes as those of the identification target drug, using the information acquired by the matched drug extracting unit 110 from the drug master file 108. Depending on the category-based significance set by the significance setting unit, the score modifying unit 114 modifies the score value sᵢ to calculate a modified score value s_{ci} as in the following expression (1) or expression (2), for example.

$$\begin{matrix}[ Expression 1 ] & \\ {s}_{ci} = {s}_{i} + {\sum }_{j} {k}_{j} \frac{1}{{N}_{j}^{α}} {δ}_{ij} & ( 1 )\end{matrix}$$

$$\begin{matrix}[ Expression 2 ] & \\ {s}_{ci} = {s}_{i} + {\sum }_{j} {k}_{j} \frac{1}{{N}_{j}^{α}} {c}_{ij} & ( 2 )\end{matrix}$$

Here, kⱼ indicates a weighting factor for a category j, and kⱼ corresponds to a significance of information indicating that the drug type belongs to the category j.

Nⱼ indicates a number of drug types belonging to the category j. As the value of Nⱼ decreases, it means that the rarity of the category j increases. As the value of Nⱼ increases, it means that the rarity of the category j decreases.

α is a constant indicating a degree of reflection of the rarity of a drug belonging to a category, onto the score value. The reason why α is considered is based on an idea that information indicating that a drug type belongs to the category with high rarity, further may help identification of a drug type. Note that α=0 corresponds to case where rarity is not reflected to the modified score value.

δᵢⱼ indicates that the drug i belongs to a category j on the drug master file 108. δᵢⱼ is a value (discrete value) that takes “1” if it is determined that the drug i belongs to the category j when the image IM of the identification target drug is input to the attribute classification model 106, otherwise, δᵢⱼ takes “0”.

Cᵢⱼ indicates that the drug i belongs to the category j on the drug master file 108. Cᵢⱼ is a score value or a certainty factor (continuous value) regarding whether the identification target drug belongs to the category j or not. Cᵢⱼ is output from the attribute classification model 106 when the image IM of the identification target drug is input to the attribute classification model 106.

δᵢⱼ may be a value acquired by binarizing continuous values cᵢⱼ indicating accuracies (certainty factors) the categories j calculated by the attribute classification model 106, with reference to a predetermined threshold value.

The score value sᵢ output from the drug identification model 104 is an example of the “first score value” in the present disclosure. kⱼ indicating a significance of the category j is an example of “value set for an attribute” in the present disclosure. The modified score value s_{ci} modified based on Expression (1) or (2) by using kⱼ is an example of the “second score value” in the present disclosure.

The candidate presenting unit 116 presents final drug candidates based on the magnitude of the modified score value s_{ci} modified by the score modifying unit 114. The candidate presenting unit 116 displays higher-ranking candidates in decreasing order, for example, of the modified score values s_{ci} on the touch panel display 14. Here, in a case where an instruction to change the significance setting is input from a user while the candidates are being displayed, the score modifying unit 114 re-calculates the score values s_{ci} based on the changed setting and the candidate presenting unit 116 presents higher-ranking candidates based on the re-calculated score value s_{ci}. In this way, in conjunction with a change of the significance setting, the drug candidate list to be presented is updated.

The drug confirming unit 118 receives an instruction to confirm a type of the identification target drug from a user, and performs processing for confirming the identified type of the drug.

### Description of Operations by Drug Identification Apparatus 100

FIG. 5 is a table schematically showing an example of information registered with the drug master file 108. The drug master file 108 records information regarding a color (white and yellow are exemplarily shown in FIG. 5) and a shape (circle and ellipse are exemplarily shown in FIG. 5) as appearance attributes of drugs i. While FIG. 5 shows records of four types of drugs Drug 1 to Drug 4, information on all drug types of drugs identifiable by the drug identification model 104 are recorded in the drug master file 108. The categories “White”, “Yellow”, “Circle” and “Ellipse” shown in FIG. 5 are examples of the appearance attribute identifiable from an appearance of a drug by a human visual sense.

The information “1” or “0” shown in each cell of a row corresponding to each category indicates whether the drug corresponds to the category or not. Here, the information is “1” when the drug corresponds to the category and the information “0” when the drug does not correspond to the category. For each category, a significance (k1, k2, k3, k4) is set. In the example in FIG. 5, k1=0.4, k2=0.4, k3=0.03, k4=0.03 are set, and it can be seen that the significances of the attributes relating to “color” among appearance attributes are set higher. Here, as an example of a simple case where a score value sᵢ output from the drug identification model 104 is modified, a case where α=0 in Expression (1) is described.

Note that, while FIG. 5 shows characters (engraved characters) in an engraved mark (that is, inscription, or imprint) given to each drug and an image of each drug, the drug master file 108 may not necessarily include information on the engraved characters.

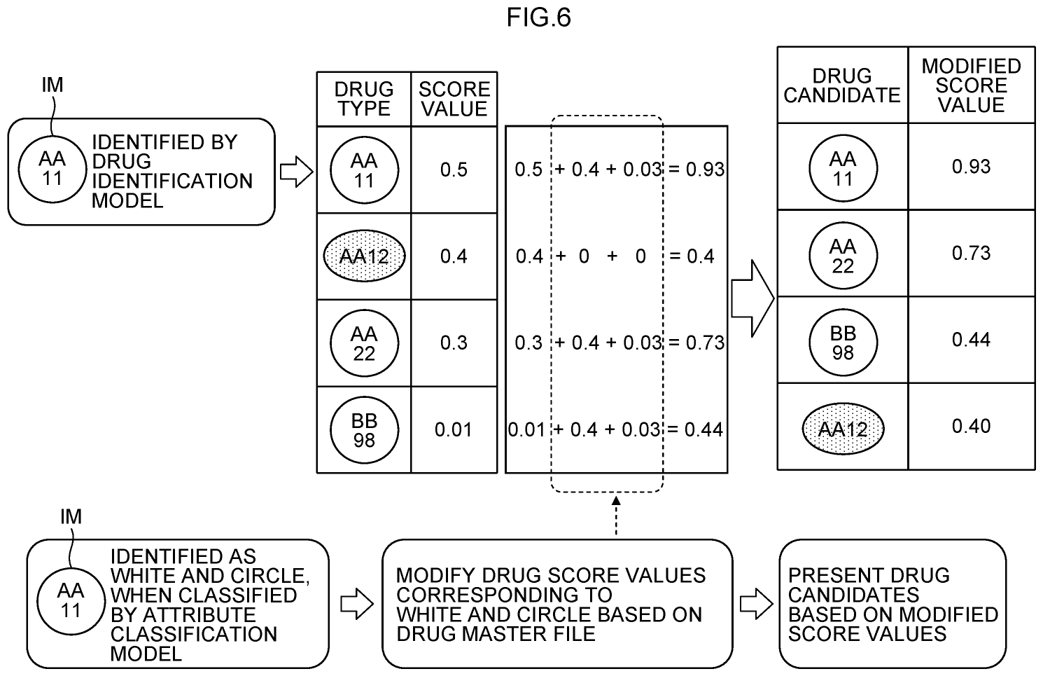

Operations by the drug identification apparatus 100 according to the embodiment are specifically described with reference to the example shown in FIG. 6. As shown in FIG. 6, it is assumed that, when the image IM of the identification target drug having the engraved mark “AA11” is input to the drug identification model 104, the drug identification model 104 outputs score values including: a score value of 0.5 for Drug 1 having an engraved mark “AA11”; a score value of 0.4 for Drug 2 having an engraved mark “AA12”: a score value of 0.3 for Drug 4 having an engraved mark “AA22”; and a score value of “0.01” for Drug 3 having an engraved mark of “BB98”. Considering these score values, it is expected that the drug identification model 104 places importance on an appearance similarity of “engraved characters” that are not included in the drug master file 108.

Assuming that higher-ranking candidates are presented based on such score values, Drug 2 having the engraved characters “AA12” is presented as the second candidate from the top. However, because Drug 2 (AA12) is a yellow and elliptical tablet, it seems that Drug 2 is clearly different from the identification target drug (white and circular tablet) by human sense.

In the drug identification apparatus 100 according to the embodiment, the score values output from the drug identification model 104 are modified in the following manner. That is, when the captured image IM of the identification target drug having the engraved mark “AA11” is input to the attribute classification model 106, the attribute classification model 106 outputs a result indicating that the identification target drug belongs to two categories of “white” and “circle”.

The matched drug extracting unit 110 extracts drugs belonging to at least one category of “white” and “circle” from all drug types registered with the drug master file 108 based on the output from the attribute classification model 106. The score modifying unit 114 adds a significance of k1=0.4 for white and a significance of k3=0.03 for circle to the score value sᵢ for the drugs extracted by the matched drug extracting unit 110.

In the example shown in FIG. 6, since Drug 1 (engraved characters: AA11), Drug 3 (engraved characters: BB98), and Drug 4 (engraved characters: AA22) belong to categories of “white” and “circle”, “0.4+0.03” is added to the score values sᵢ of those drugs to modify the score values of the drugs. In this way, score values of the drugs belonging to categories of “white” and “circle” identified by the attribute classification model 106, are increased. On the other hand, since Drug 2 (engraved characters: AA12) does not belong to any one of categories “white” and “circle”, the score value for Drug 2 is not modified so as to keep the original score value (0.40) as it is.

Therefore, the modified score value is “0.93” for Drug 1 (engraved characters AA11), “0.40” (not modified) for Drug 2 (engraved characters: AA12), “0.44” for Drug 3 (engraved characters: BB98), and “0.73” for Drug 4 (engraved characters: AA22). In a case where Drag 1, Drag 2, Drag 3 and Drag 4 are re-arranged in decreasing order of the modified score values, the resulting order is Drug 1 (0.93), Drug 4 (0.73), Drug 3 (0.44), Drug 2 (0.40) so that the Drug 2 having different color from that of the identification target drug can be placed lower in the order comparing the order before the modification. Thus, the preset policy that “identification with importance placed on color” can be reflected.

On the touch panel display 14, a drug candidate list is displayed in such a manner that higher-ranking candidates are arranged in order of the magnitude of the modified score value s_{ci}. As exemplarily shown in FIG. 6, the order of arrangement of the higher-ranking candidates presented based on the modified score value s_{ci} is close to the human sense of recognition (sense of similarity). Therefore, it can be expected that the identification result is more reasonable to a user.

Note that numerical values such as significances described with reference to FIG. 6 are just examples. The modified score values to be calculated vary in accordance with the set significance parameters. A significance parameter for each attribute may be set to a proper value so that the modified score value can be closer to human sense of similarity. For example, the proper value and range for the significance parameter may be determined by trial and error, or may be determined by automatic optimization search by increasing and/or decreasing the parameter.

### Examples of Drug Identification Method

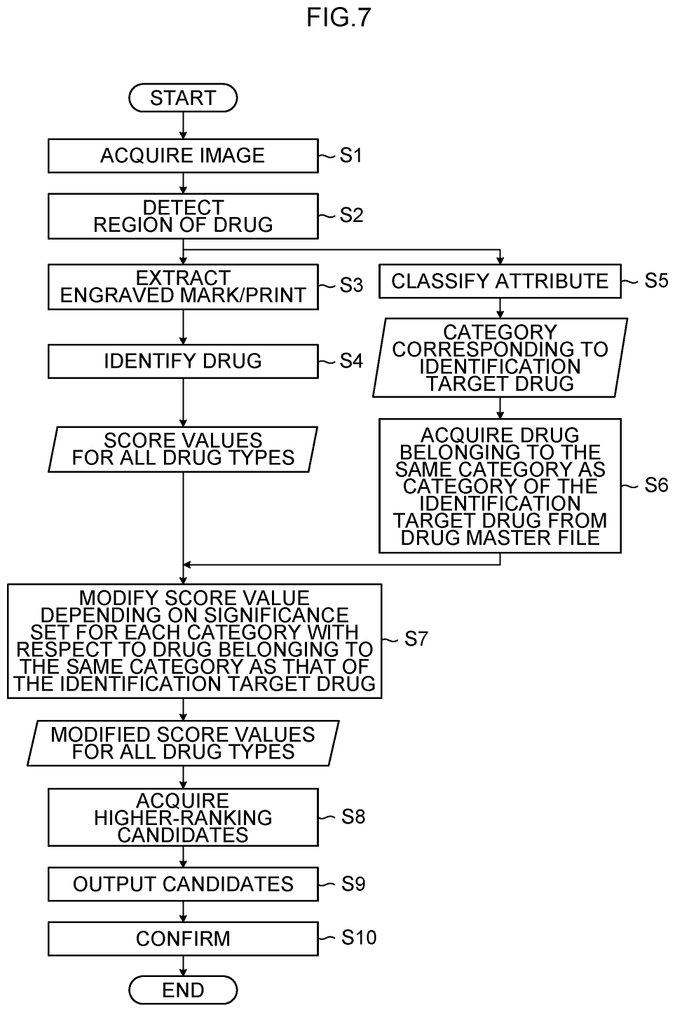

FIG. 7 is a flowchart showing an example of a drug identification method to be executed by the drug identification apparatus 100 according to the embodiment. The drug identification method includes steps shown in FIG. 7, and is implemented by the CPU 28 which executes a program read out from the memory 34. Note that the program for implementing the drug identification method may be provided via the wireless communication unit 30 or the external input/output unit 40.

In step S1, the CPU 28 acquires an image obtained by capturing an identification target drug. For example, the CPU 28 acquires the image captured by the out-camera 22. Here, a plurality of identification target drugs may be captured in the acquired image. In a case where a marker is captured in the acquired image, the CPU 28 may perform standardization of the photographing distance and photographing viewpoint of the captured image based on the marker so as to create a standardized image. Also, the CPU 28 may perform correction processing such as color tone correction on the acquired image.

In step S2, the CPU 28 detects a region of a drug from the acquired image. Processing for detecting the region of the drug is executed by using a trained model that is trained so as to, for example, extract a region of a drug from inside the image. The CPU 28 cuts out each region of the detected drug from inside the image, and acquires a region image (hereinafter, called a drug image) for each drug. The image IM described with reference to FIGS. 4 and 6, may be a drug image cut out for each drug.

In step S3, the CPU 28 extracts an engraved mark and/or print on the identification target drug from the drug image, and generates engraved mark/print extracted image. The engraved mark/print-extracted image is an image having a relatively higher luminance in an engraved mark part or a print part than luminance in the other parts different from the engraved mark part or print part. Note that the term “engraved mark/print-extracted image” embraces an image acquired by extracting not only an engraved mark but also print given to a tablet or a capsule. The term “engraved mark/print-extracted image” may be called “text/symbol-extracted image”. The term “engraved mark/print” embraces concept such as “engraved mark”, “print”, “printed symbol”, “identification symbol”, or “letter symbol” about the tablet or the capsule drug.

In step S4, the CPU 28 identifies a type of the identification target drug from the drug image by using the drug identification model 104. When the drug image is input to the drug identification model 104, the drug identification model 104 outputs score values sᵢ for all identifiable drug types. Note that a combination of the drug image and the engraved mark/print-extracted image may be input to the drug identification model 104, and the drug identification model 104 may output score values sᵢ for all drug types.

Further, the CPU 28 uses the attribute classification model 106 in step S5 to identify an appearance attribute of the identification target drug from the drug image in parallel with the processing in step S3 and step S4. When the drug image is input to the attribute classification model 106, the attribute classification model 106 outputs information on a category to which the identification target drug belongs.

In step S6, the CPU 28 inquires the drug master file 108 about drugs belonging to the same category as the category of the identification target drug output from the attribute classification model 106, and acquires drugs belonging to the same category as the category of the identification target drug from the drug master file 108.

Then, in step S7, the CPU 28 modifies the score values sᵢ for the drugs belonging to the same category as that of the identification target drug, according to the significance set for each category. The CPU 28 calculates modified score values s_{ci} for all drug types by using the aforementioned Expression (1) or (2).

In step S8, the CPU 28 acquires higher-ranking candidates having high modified score values s_{ci}, and creates a drug candidate list showing the higher-ranking candidates in descending order of the modified score values s_{ci}.

In step S9, the CPU 28 outputs the higher-ranking candidates acquired in step S8 as candidates for the type of the identification target drug. The CPU 28 displays the higher-ranking candidates based on the magnitudes of the modified score values in a selectable manner on the touch panel display 14. The user can input an instruction to confirm the type of the identification target drug by selecting a correct drug type among the candidates displayed on the touch panel display 14.

The CPU 28 may further receive input of various instruction such as an instruction to modify display of candidates for the drug type or an instruction to transit to other processing such as text search based on engraved mark/print through a user interface such as the touch panel display 14. The user can check the presented candidates of drug type, and, through a user interface of the touch panel display 14, input an instruction to confirm the drug type, or input an instruction to correct displayed candidates, move to text search or the like.

In step S10, the CPU 28 receives the instruction to confirm the type of the identification target drug via the touch panel display 14 or an audio input, and performs processing for confirming the type of the identification target drug in accordance with the received instruction.

After the processing in steps S3 to S10 are performed for all of the identification target drugs imaged in the image acquired in step S1, the CPU 28 ends the flowchart in FIG. 7.

With the drug identification apparatus 100 according to the embodiment, the score values sᵢ are modified, on the premise of the score values sᵢ calculated by the drug identification model 104 and in consideration of the appearance attribute which is based on output from the attribute classification model 106, and candidates are presented based on the modified score values s_{ci}. Thus, it is possible to present candidates that are reasonable even in view of human sense.

### Hardware Configuration of Processing Units

Hardware structures of processing units that executes various kinds of processing such as the image acquiring unit 102, matched drug extracting unit 110, significance setting unit 112, score modifying unit 114, candidate presenting unit 116, and drug confirming unit 118 described with reference to FIG. 4, are various processors as described below.

The various processors include: a central processing unit (CPU) that is a general purpose processor executing programs and functioning as various processing units; a graphics processing unit (GPU) that is a processor being specific to image processing; a programmable logic device (PLD) that is a processor having a circuit configuration changeable after manufactured, such as a field programmable gate array (FPGA); a dedicated electric circuit that is a processor having a circuit configuration designed especially for executing specific processing such as application specific integrated circuit (ASIC); and the like.

One processing unit may be composed of one of those various processors or may be composed of two or more processors of the same kind or of different kinds. For example, one processing unit may be composed of FPGAs, a combination of a CPU and an FPGA, a combination of a CPU and a GPU, or the like. Also, processing units may be composed of one processor. As an example, in which processing units are composed of one processor, first, there is a form in which one processor is composed of a combination of one or more CPUs and software, as typified by a computer such as a client or a server, where the processor functions as processing units. Secondly, there is a form in which a processor is used which applies an integrated circuit (IC) chip to implement functionality of an entire system including processing units as typified by a system-on-chip (SoC) and the like. In this way, various processing units are formed by employing one or more of the various processors as described above as the hardware structure.

Further, a hardware structure of those various processors is, more specifically, an electric circuitry in which circuit elements such as semiconductor elements are combined.

### Regarding Program Implementing Functionality of Drug Identification Apparatus 100

The processing functions of the drug identification apparatus 100 can be implemented by information processing devices in various forms such as, without limiting to the smartphone 10, a tablet type computer, a personal computer, a workstation, or a server. The processing functions of the drug identification apparatus 100 may be implemented by a computer system including computers.

A program for causing a computer to implement some or all of the processing functions of the drug identification apparatus 100 described in the embodiment may be recorded on a computer-readable medium that is a tangible non-transitory information storage medium such as an optical disk, a magnetic disk, a semiconductor memory or the like. Through this information storage medium, the program can be provided. Instead of the aspect in which a program is recorded in such a tangible non-transitory information recording medium, an electric communication line such as the Internet can be used to provide signals of the program as a download service.

Further, some or all of the processing functions of the drug identification apparatus 100 may be provided as an application server so as to perform service to provide the processing functions through an electric communication line.

### Effects of Embodiment

The drug identification apparatus 100 according to the embodiment achieves advantageous effects as follows.

[1] Modification that fits human sense of similarity is performed proactively on score values sᵢ for drug candidate output from the machine learning-based drug identification model 104 so that the candidates can be presented in an order that is reasonable to human.

[2] It is possible to customize an appearance property (feature) on which importance is to be placed, for each user or for each determination of a drug type,

[3] After training the drug identification model 104 and independent of the drug identification model 104, it is possible to add a mechanism (attribute classification model 106, drug master file 108, and score modifying unit 114) that considers an appearance attribute on which importance is to be placed, and control candidates to be presented. Although training the drug identification model 104 costs high, the attribute classification model 106 can be generated at relatively low cost. According to the embodiment, without rebuilding the high-cost drug identification model 104, an additional configuration (the attribute classification model 106, the drug master file 108, and the score modifying unit 114) is combined in order to present candidates close to human sense of similarity.

[4] For example, by pre-setting higher significances to special (rare) attributes such as “pentagon” or “triangle” for shape of drugs, the score values may be modified so that, when such a special attribute is identified by the attribute classification model 106, candidates are limited to drug types having the same attribute, and are presented to the user.

[5] Even for a drug that is not learned by the drug identification model 104 and the attribute classification model 106, when its appearance attribute is known and is learned by the attribute classification model 106, there is a possibility that the drug can be selected as a candidate as long as the drug is registered with the drug master file 108.

### Variation Example 1

The means for identifying an appearance attribute of an identification target drug from an image is not limited to an AI model such as the attribute classification model 106. It is only required that one or more appearance attributes are seized from an input image and classification is performed based on the attributes. It is possible to apply various image processing technologies other than AI, such as image recognition by template matching approach.

### Variation Example 2

Instead of or in addition to category information output from the attribute classification model 106, numerical values (for example, numerical values indicating sizes of identification target drugs) may be calculated such as continuous values corresponding to appearance attributes of the identification target drugs from an image, and the score values sᵢ may be modified in accordance with the continuous values.

### Variation Example 3

In the embodiment above, as an example, a case in which the score values sᵢ are modified by adding a value that varies depending on the significance of an applicable attribute, to the score values sᵢ of the drug types matching an appearance attribute of an identification target drug. However, various operation expressions including multiplication are applicable, without limiting to modification by “addition” for computing the score modification. Further, the modification is not limited to a case where the modified score values is increased from the score values sᵢ before the modification. For example, a negative value may be defined for kⱼ indicating a significance so that the modified score values may be decreased from the score values sᵢ before the modification.

Instead of a modifying the score values sᵢ of drug types matching an appearance attribute of the identification target drug, a modification may be performed so as to reduce the score values sᵢ of the (unmatched) drug type that does not match the appearance attribute of the identification target drug. Thereby, the unmatched drug type may be placed lower in the order. Further, the drug master file 108 may be searched by using category information output from the attribute classification model 106, so as to extract information on a drug type matching the appearance attribute of the identification target drug and information on an unmatched drug type, from the drug master file 108.

### Variation Example 4

In the embodiment above, explanation is described about the case where a drug is discriminated. However, the technology of the present disclosure is also applicable to a case where drug audit is to be performed.

### Others

The technical scope of the invention is not limited to the scopes described in the embodiments and variation examples above. Configurations and the like according to the embodiments and the variation examples can be changed without departing from the spirit of the invention and can be combined as appropriate between or among the embodiments and the variation examples.

### REFERENCE SIGNS LIST

10 smartphone
12 housing
14 touch panel display
16 speaker
18 microphone
20 in-camera
22 out-camera
24 light
26 switch
30 wireless communication unit
32 talking unit
34 memory
36 internal storage unit
38 external storage unit
40 external input/output unit
42 GPS receiving unit
44 power supply unit
100 drug identification apparatus
102 image acquiring unit
104 drug identification model
106 attribute classification model
108 drug master file
110 matched drug extracting unit
112 significance setting unit
114 score modifying unit
116 candidate presenting unit
118 drug confirming unit
IM image
ST1, ST2, STn GPS satellite
S1-S10 steps of drug identification method

What is claimed is:

1. A drug identification apparatus comprising:
one or more processors; and
one or more storages,
wherein the one or more storages are configured to store:
a first trained model trained to identify a type of an identification target drug from an image obtained by capturing the identification target drug; and
a drug master file including information on one or more appearance attributes for each of a plurality of types of drugs, and
the one or more processors are configured to:
calculate a first score value indicating likelihood of being a type of the identification target drug, for each of a plurality of types of drugs identifiable from the image by the first trained model;
identify one or more appearance attributes of the identification target drug from the image;
acquire from the drug master file, information on types of drugs matching the one or more appearance attributes of the identification target drug, and calculate a second score value by using the first score value and values set for the one or more appearance attributes; and
present candidates for the type of the identification target drug based on the second score value.

2. The drug identification apparatus according to claim 1,
wherein the one or more storages store a second trained model trained to identify one or more appearance attributes of the identification target drug from the image, and
the one or more processors identify whether or not the identification target drug belongs to a category corresponding to the one or more appearance attributes by using the second trained model.

3. The drug identification apparatus according to claim 1, wherein the values set for the one re more appearance attributes are values depending on significances of the appearance attributes.

4. The drug identification apparatus according to claim 3, wherein the one or more processors receive an instruction to change settings for the significances, and set values depending on the significances of the appearance attributes based on the received instruction.

5. The drug identification apparatus according to claim 4, wherein the values depending on the significances are settable for each user.

6. The drug identification apparatus according to claim 4, wherein the values depending on the significances are settable at a time desired by a user.

7. The drug identification apparatus according to claim 3, comprising
an input device,
wherein the one or more processors receive an instruction regarding the settings for the significances from the input device.

8. The drug identification apparatus according to claim 3,
wherein the drug master file includes information on a plurality of appearance attributes including an attribute relating to a shape of a drug and an attribute relating to a color thereof, and
the one or more processors receive an instruction to specify whether the second score value is calculated with importance placed on the attribute relating to a shape or the attribute relating to a color, and change significance of at least one of the attribute relating to a shape and the attribute relating to a color, based on the received instruction.

9. The drug identification apparatus according to claim 3, wherein the one or more processors calculate the second score value by adding a value depending on the significance of each appearance attribute, to the first score value for each of the types of drugs matching the one or more appearance attributes of the identification target drug.

10. The drug identification apparatus according to claim 1, wherein the one or more processors calculate the second score value by modifying the first score value for each of the types of drugs matching the one or more appearance attributes of the identification target drug, with a value set for each appearance attribute.

11. The drug identification apparatus according to claim 1,
wherein the drug master file includes information on a plurality of appearance attributes including an attribute relating to at least one of a shape and a color of a drug, and
the one or more processors identify whether the identification target drug matches the plurality of appearance attributes or not.

12. The drug identification apparatus according to claim 1, wherein the one or more processors present a drug candidate list in which the candidates are arranged in order of magnitude of the second score value.

13. The drug identification apparatus according to claim 1, comprising
a display configured to display the candidates for the type of the identification target drug.

14. The drug identification apparatus according to claim 1, comprising
a camera configured to capture the image of the identification target drug.

15. A drug identification method to be executed by one or more processors, including:
with a first trained model trained to identify a type of an identification target drug from an image obtained by capturing the identification target drug, calculating from the image, a first score value indicating likelihood of being a type of the identification target drug, for each of a plurality of types of drugs;
identifying from the image, one or more appearance attributes of the identification target drug;
acquiring information on types of drugs matching the one or more appearance attribute of the identification target drug, from drug master file including information on one or more appearance attributes, for each of a plurality of types of drugs identifiable by the first trained model;
calculating a second score value by using the first score value and values set for the one or more appearance attributes, based on information on types of drugs matching the one or more appearance attributes of the identification target drug; and
presenting candidates for the type of the identification target drug based on the second score value.

16. A non-transitory, computer-readable tangible recording medium which records thereon a program for causing, when read by a computer, the computer to implement:
a function of, with a first trained model trained to identify a type of an identification target drug from an image obtained by capturing the identification target drug, calculating from the image, a first score value indicating likelihood of being a type of the identification target drug, for each of a plurality of types of drugs;
a function of identifying from the image, one or more appearance attributes of the identification target drug;
a function of acquiring information on types of drugs matching the one or more appearance attributes of the identification target drug, from drug master file including information on the one or more appearance attributes, for each of a plurality of types of drugs identifiable by the first trained model;
a function of calculating a second score value by using the first score value and values set for the one or more appearance attributes, based on information on types of drugs matching the one or more appearance attributes of the identification target drug; and
a function of presenting candidates for the type of the identification target drug based on the second score value.
